(19) United States
(12) Patent Application Publication
(10) Pub. No.: US 2025/0046991 A1
(43) Pub. Date: Feb. 6, 2025

(54) ELECTRONIC DEVICE AND METHOD OF MANUFACTURING THE SAME

(71) Applicant: InnoLux Corporation, Miao-Li County (TW)

(72) Inventors: Zi-Zhong WANG, Miao-Li County (TW); Kuan-Hsueh LIN, Miao-Li County (TW); Yung-Fu CHANG, Miao-Li County (TW); Lung-Shu HUANG, Miao-Li County (TW)

(21) Appl. No.: 18/763,072

(22) Filed: Jul. 3, 2024

Related U.S. Application Data
(60) Provisional application No. 63/517,123, filed on Aug. 2, 2023.

(30) Foreign Application Priority Data
Apr. 26, 2024 (CN) 202410509840.4

(51) Int. Cl. H01Q 1/52; H01Q 1/22; H01Q 1/24

(52) U.S. Cl. CPC H01Q 1/526; H01Q 1/2283; H01Q 1/243

(57) ABSTRACT

An electronic device includes a circuit structure, an electronic component electrically connected to the circuit structure, an antenna unit disposed on the circuit structure, and a shielding layer surrounding the electronic component. The circuit structure has a first surface and a second surface opposite to the first surface. The first surface has a first portion, a second portion, and a third portion, wherein the third portion connects the first portion and the second portion. In the normal direction of the electronic device, the third portion is closer to the second surface than the first portion or the second portion, thereby forming a recess. The electronic component is disposed in the recess. The antenna unit is disposed on the first surface of the circuit structure and is electrically connected to the electronic component through the circuit structure.

### CROSS REFERENCE TO RELATED APPLICATIONS

This application claims priority of China Patent Application No. 202410509840.4, filed on Apr. 26, 2024, which claims the benefit of U.S. Provisional Application No. 63/517,123, filed on Aug. 2, 2023, the entirety of which is incorporated by reference herein.

### BACKGROUND OF THE INVENTION

### Field of the Invention

The present disclosure relates to an electronic device and a method of manufacturing the same, and in particular, to an electronic device including a shielding layer and a method of manufacturing the same.

### Description of the Related Art

With the development of digital technology, electronic devices have become widely used in in everyday life and are constantly evolving to become lighter, thinner, shorter and more fashionable. These electronic devices may include packaging devices and antenna devices. To achieve product miniaturization, an antenna-in-package (AiP) structure is provided, which integrates an antenna device and other electronic components or circuits into a single package.

### BRIEF SUMMARY OF THE INVENTION

An embodiment of the present invention provides an electronic device. The electronic device includes a circuit structure, an electronic component electrically connected to the circuit structure, an antenna unit disposed on the circuit structure, and a shielding layer surrounding the electronic component. The circuit structure has a first surface and a second surface opposite the first surface. The first surface has a first portion, a second portion, and a third portion, wherein the third portion connects the first portion and the second portion. In the normal direction of the electronic device, the first portion and the second portion are farther away from the second surface than the third portion, thereby forming a recess. The electronic component may be disposed in the recess. The antenna unit is disposed corresponding to at least one of the first portion and the second portion of the first surface and is electrically connected to the electronic component through the circuit structure.

An embodiment of the present invention provides a method of manufacturing an electronic device. The method of manufacturing the electronic device includes providing a circuit structure that has a first surface and a second surface. The second surface is opposite the first surface. The first surface has a first portion, a second portion, and a third portion. The third portion connects the first portion to the second portion. The first portion and the second portion are farther away from the second surface than the third portion, thereby forming a recess in the normal direction of the electronic device. The method includes disposing an electronic component in the recess of the circuit structure. The electronic component is electrically connected to the circuit structure. The method includes forming a shielding material layer on the electronic component and the circuit structure. The method includes patterning the shielding material layer to form a shielding layer that surrounds the electronic component. The method includes disposing an antenna unit on the first surface of the circuit structure. The antenna unit is electrically connected to the electronic component through the circuit structure.

### BRIEF DESCRIPTION OF THE DRAWINGS

The present invention can be more fully understood by reading the subsequent detailed description and examples with references made to the accompanying drawings, wherein:

FIG. 1A is a top schematic view of an electronic device according to an embodiment of the present disclosure;

FIG. 1B is a cross-sectional schematic view of the electronic device shown in FIG. 1A along a line AA′ according to an embodiment of the present disclosure;

FIG. 2A is a cross-sectional schematic view of an electronic device according to another embodiment of the present disclosure;

FIG. 2B is a cross-sectional schematic view of an electronic device according to another embodiment of the present disclosure;

FIG. 2C is a cross-sectional schematic view of an electronic device according to another embodiment of the present disclosure;

FIG. 3 is a flowchart of a method of manufacturing the electronic device according to an embodiment of the present disclosure;

FIGS. 4A to 4H are cross-sectional schematic views of an electronic device during manufacturing according to an embodiment of the present disclosure; and

FIGS. 5A to 5D are cross-sectional schematic views of an electronic device during manufacturing according to another embodiment of the present disclosure.

### DETAILED DESCRIPTION OF THE INVENTION

The following description is made for the purpose of illustrating the general principles of the disclosure and should not be taken in a limiting sense. The scope of the disclosure is determined by reference to the appended claims. Reference will now be made in detail to exemplary embodiments of the present disclosure, examples of which are illustrated in the accompanying drawings. Whenever possible, the same reference numbers are used in the drawings and descriptions to refer to the same or similar parts.

The present disclosure may be understood by referring to the following detailed description and combined with the accompanying drawings. It should be noted that in order to make it easy for readers to understand and for the simplicity of the drawings, many of the drawings in the present disclosure only depict a portion of an electronic device, and certain components in the drawings are not drawn to actual scale. In addition, the number and size of components in the drawings are only for illustration and are not intended to limit the scope of the present disclosure.

The directional terms mentioned in the disclosure, such as “up”, “down”, “front”, “back”, “left”, “right” only refer to the directions of the accompanying drawings. Therefore, the directional terms used herein are illustrative and not intended to limit the disclosure. It should be understood that if a device in an accompanying drawing is turned so that it is upside down, components recited on the “bottom” side will become the components on the “top” side. In the accompanying drawings, the drawings illustrate general features of the methods, structures and/or materials used in specific embodiments. However, these accompanying drawings should not be construed as defining or limiting the scope or property of what is covered by these embodiments. For example, relative sizes, thicknesses and positions of the various layers, regions and/or structures may be reduced or enlarged for clarity.

In the present disclosure, descriptions of a structure (or layer, component or substrate) being on/above another structure (or layer, component or substrate) may mean that the two structures are adjacent and directly connected, or that the two structures are adjacent and indirectly connected. Indirect connection means that there is at least one intermediate structure (or intermediate layer, intermediate component, intermediate substrate, intermediate spacer) between two structures. A lower surface of the structure is adjacent to or directly connected to an upper surface of the intermediate structure, and an upper surface of the other structure is adjacent to or directly connected to a lower surface of the intermediate structure. The intermediate structure may be a single-layer or multi-layer physical structure or a non-physical structure without limitation. In the disclosure, when a structure is disposed “on” another structure, it may mean that the structure is “directly” on the other structure, or that the structure is “indirectly” on the other structure, i.e. there is at least one structure is between the structure and the other structure.

In some embodiments of the present disclosure, unless otherwise defined, terms related to joining and connecting, such as “connection”, “interconnection”, etc., may mean that two structures are in direct contact, or may also mean that the two structures are not in direct contact (indirect contact) and other structures are between the two structures. The terms related to joining and connecting may also include the situation where both structures are movable or both structures are fixed. In addition, the term “electrical connection” includes a transfer of energy between two structures by direct or indirect electrical connection, or a transfer of energy between two separate structures by mutual induction.

The term “A surrounds B” in the disclosure indicates that at least a portion of B is in A, and in a cross-sectional view, A is in direct or indirect contact with at least one side surface of B. The term “A indirectly contacts B” used in this disclosure indicates that there is an intermediate structure between A and B. The term “A directly contacts B” used in this disclosure indicates that there is no intermediate structure between A and B.

In the disclosure, the terms “about”, “equal to”, “equal” or “the same”, “substantially” or “approximately” usually indicates a value of a given value or range that varies within 20%, or a value of a given value or range that varies within 10%, within 5%, or within 3%, or within 2%, or within 1%, or within 0.5%. The term “a-b” refers to a range that includes all values greater than or equal to a, less than or equal to b, and all values between a and b.

Ordinal numbers used in the specification and claims, such as “first”, “second”, etc., are used to modify elements. The ordinal numbers do not imply or represent numbers of the element (or elements). The ordinal numbers do not represent the order of one element over another or the order of manufacturing method. The ordinal numbers are only used to clearly distinguish two elements having the same name. The claims and the specification may not use the same terms. Therefore, the first element in the specification may be the second component in the claim.

Throughout the disclosure and the appended claims, some terms are used to refer to specific components. Those skilled in the art will understand that electronic device manufacturers may refer to the same component by different names. The disclosure is not intended to differentiate between components that have the same function but have different names.

Unless otherwise defined, all terms (including technical and scientific terms) used herein have the same meaning as commonly understood by a person skilled in the art to which the disclosure pertains. It will be further understood that terms, such as those defined in commonly used dictionaries, should be interpreted as having a meaning consistent with the relevant technology and the context or background of this disclosure and will not be interpreted in an idealized or overly formal sense unless expressly so defined herein.

The electronic device may include a power module, an imaging device, a laminating device, a display device, a backlight device, an antenna device, a sensing device, a packaging device, a splicing device, a touch electronic device (touch display), a curved electronic device (curved display) or a non-rectangular electronic device (free shape display), but is not limited thereto. The electronic device may include, for example, liquid crystals, light emitting diodes, fluorescences, phosphors, other suitable display medias, or any combination of the foregoing, but are not limited thereto. The display device may be a non-self-luminous display device or a self-luminous display device. The antenna device may be a liquid crystal type antenna device or a non-liquid crystal type antenna device. The sensing device may be a sensing device that senses capacitance, light, heat energy or ultrasonic waves, but is not limited thereto. The splicing device may be, for example, a display splicing device or an antenna splicing device, but is not limited thereto.

The electronic device may be a bendable or flexible electronic device. The shape of the electronic device may be a rectangular shape, a circular shape, a polygonal shape, a shape with curved edges, or other suitable shapes. The processes of the electronic devices described in the present disclosure may be applied, for example, in a wafer-level package process (WLP) or a panel-level package (PLP) process, either a chip first process or a chip last (RDL first) process.

The electronic device of the present disclosure may include electronic components. The electronic components may include passive components, active components, or a combination of the foregoing. Examples of the passive components may include capacitors, resistors, inductors, varactor diodes, variable capacitors, filters, diodes, transistors, sensors, microelectromechanical system (MEMS) components, liquid crystal chips, etc., but are not limited thereto. The diodes may include light emitting diodes or non-light emitting diodes. The diodes may include P-N junction diodes, PIN diodes or constant current diodes. The light emitting diodes may include, for example, organic light emitting diodes (OLEDs), submillimeter light emitting diodes (mini LEDs), micro light emitting diodes (micro LEDs), quantum dot light emitting diodes (quantum dot LEDs), fluorescence diodes, phosphor diodes or other suitable materials, or any combination of the foregoing, but are not limited thereto. The sensing device may include, for example, capacitive sensors, optical sensors, electromagnetic sensors, fingerprint sensors (FPS), touch sensors, antennas, or pen sensors, etc., but are not limited to thereto. Electronic components may include dies or LED dies, which may be a die made of silicon (Si), gallium arsenide (GaAs), gallium nitride (GaN), silicon carbide (SiC), sapphire or a glass substrate, but is not limited thereto. In another embodiment, the above-mentioned chips may include a semiconductor packaging component, such as a ball grid array (BGA) packaging component, a chip size package (CSP) component, a system on package (SoC), a system in package (SiP), an antenna in package, (AiP), or a 2.5D/3-dimensional (2.5D/3D) semiconductor packaging component, but is not limited thereto. In another embodiment, the chip may be any flip-chip bonding component, such as integrated circuits (ICs), transistors, controlled silicon rectifiers, valves, thin film transistors, capacitors, inductors, variable capacitors, filters, resistors, diodes, microelectromechanical system (MEMS) components, liquid crystal chips, etc., but are not limited thereto. In addition, the chip may include, for example, a diode or a semiconductor die, but is not limited thereto. The chip may be a known good die (KGD), which may include various electronic components, such as (but not limited to) lines, transistors, circuit boards, etc. Adjacent chips may have different functions, such as integrated circuits, RFICs, and D-RAMs, but are not limited thereto.

It should be understood that according to the embodiments of the present disclosure, the depth, thickness, width or height of each element, or the space of the components or the distance between them may be measured using an optical microscope (OM), a scanning electron microscope (SEM), a film thickness profile measuring gauge (α-step), an elliptical thickness gauge, or other suitable measurement methods. According to some embodiments, a scanning electron microscope may be used to obtain a cross-sectional structural image including the components to be measured, and to measure the depth, thickness, width or height of each component, or the space or distance between the components.

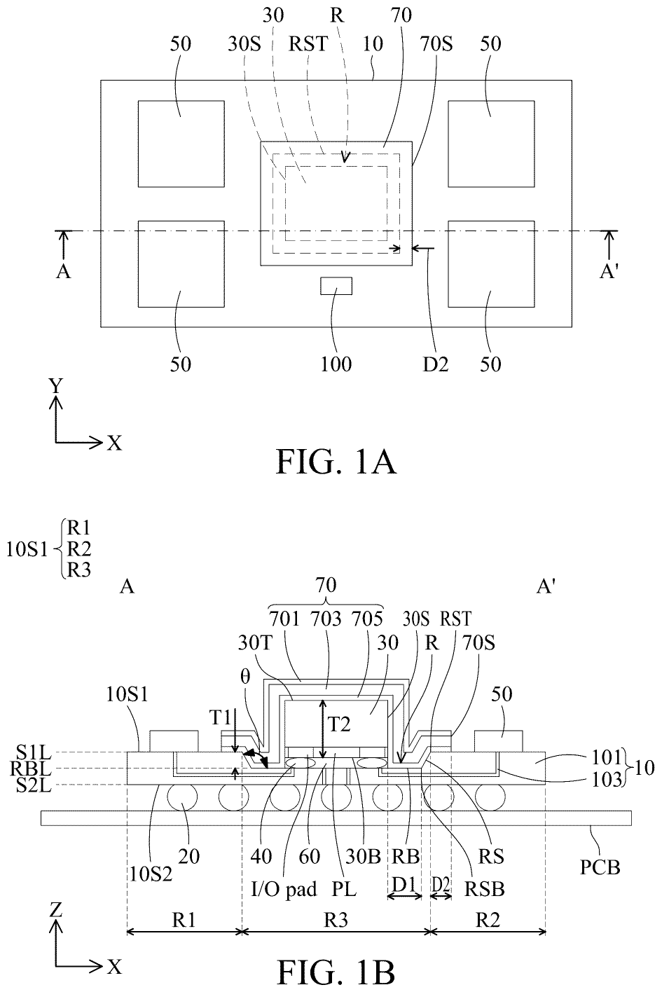

An aspect of the present disclosure provides an electronic device. FIG. 1A is a top schematic view of an electronic device according to an embodiment of the present disclosure. FIG. 1B is a cross-sectional schematic view of the electronic device shown in FIG. 1A along a line AA′ according to an embodiment of the present disclosure The term ‘cross-sectional schematic view’ used herein refers to a schematic view taken along the normal direction (i.e., Z direction) of the electronic device.

As shown in FIGS. 1A and 1B, the electronic device of the present disclosure may include a circuit structure 10, an electronic component 30 electrically connected to the circuit structure 10, an antenna unit 50 disposed on the circuit structure 10, and a shielding layer 70 surrounding the electronic component 30. The circuit structure 10 may have a first surface 10S1 and a second surface 10S2 opposite the first surface 10S1. The first surface 10S1 has a first portion R1, a second portion R2, and a third portion R3, and the third portion R3 connects the first portion R1 and the second portion R2. In the normal direction of the electronic device, the third portion R3 is closer to the second surface 10S2 than the first portion R1 and the second portion R2, thereby forming a recess R. The electronic component 30 electrically connected to the circuit structure 10 may be disposed in the recess R. The antenna unit 50 may be disposed on the first surface 10S1 of the circuit structure 10 and electrically connected to the electronic component 30 through the circuit structure 10. In some embodiments, the electronic device may further include a first bonding element 20 disposed on the second surface 10S2 of the circuit structure 10. The first bonding element 20 electrically connects to the electronic component 30. The electronic component 30 may be electrically connected to other electronic components and/or electronic devices, such as a printed circuit board (PCB), through the first bonding element 20. The electronic device may be electrically connected to other electronic components and/or electronic devices, such as a printed circuit board, through the first bonding element 20.

The circuit structure 10 may include at least one insulating layer 101 and at least one first metal line layer 103. In some embodiments, the first metal line layer 103 may be disposed in the insulating layer 101, as shown in FIG. 1B, but the present disclosure is not limited thereto. In some embodiments, at least a portion of the first metal line layer 103 may be disposed on the insulating layer 101. The circuit structure 10 may include a single or multiple the insulating layer(s) 101 and/or a single or multiple first metal line layer(s) 103. In the embodiments that the circuit structure 10 includes a plurality of insulating layers 101 and a plurality of first metal line layers 103, the insulating layers 101 and the first metal line layers 103 may be alternately and stacked in the normal direction of the electronic device (i.e., the Z-direction), such that the plurality of first metal line layers 103 may be electrically connected to each other. The first metal line layer 103 may include signal lines, RF feed lines, redistribution lines, and/or vias. At least a portion of the first metal line layer 103 may be exposed. The subsequently formed electronic component 30 and antenna unit 50 may be electrically connected to the circuit structure 10 by directly or indirectly contacting the exposed first metal line layer 103. The signal lines may include power lines, ground lines, or other signal lines. The circuit structure 10 may, for example, be a redistribution layer (RDL) structure, which may redistribute lines of the electronic device and/or further increase a fan-out area of the lines. Different electronic components may be electrically interconnected by the circuit structure 10. A spacing between two adjacent contact pads at an end of the circuit structure 10 contacting the electronic component 30 may be less than or equal to a spacing between two adjacent contact pads at an end of the circuit structure 10 away from the electronic component 30, such that the circuit structure 10 may adjust the fan-out condition of the lines, but the present disclosure is not limited thereto. Further, the circuit structure 10 may be applied to a wafer level chip scale package (WLCSP), a wafer level package (WLP), a panel level package (PLP), or other packaging methods, but the present disclosure is not limited thereto.

A material of the insulating layer 101 may include a silicon substrate, a glass substrate, a nitride, an oxide, a nitrogen oxide, a perfluoroalkoxyalkane (PFA), a resin, a photosensitive polyimide (PSPI), a polyimide (PI), an Ajinomoto build-up film (ABF), a polybenzoxazole (PBO), other suitable materials, or any combination thereof, but the present disclosure is not limited thereto. A material of the first metal line layer 103 may include a seed layer, a metal, or any combination thereof. In some embodiments, examples of the metal may include copper (Cu), aluminum (Al), molybdenum (Mo), tungsten (W), tantalum (Ta), ruthenium (Ru), gold (Au), chromium (Cr), nickel (Ni), platinum (Pt), titanium (Ti), other suitable metal materials, alloys, or combinations thereof, but the present disclosure is not limited thereto.

The circuit structure 10 may have a first surface 10S1 and a second surface 10S2 opposite the first surface 10S1. In detail, the first surface 10S1 has a first portion R1, a second portion R2, and a third portion R3, and the third portion R3 connects the first portion R1 and the second portion R2. In the normal direction of the electronic device (the Z-direction), the first portion R1 and the second portion R2 of the first surface 10S1 are farther away from the second surface 10S2 than the third portion R3 of the first surface 10S1, thereby forming a recess R. That is, the recess R has a bottom RB and a side RS connecting the bottom RB. The bottom RB of the recess R and the side RS connecting the bottom RB correspond to the third portion R3 of the first surface 10S1. The bottom RB of the recess R is between the first portion R1 and/or the second portion R2 of the first surface 10S1 and the second surface 10S2. Specifically, in the Z-direction, the distance between an extension line RBL of the bottom RB of the recess R and an extension line S1L of the first portion R1 and/or the second portion R2 of the first surface 10S1 and the distance between the extension line RBL of the bottom RB of the recess R and an extension line S2L of the second surface 10S2 are both less than the distance between the extension line S1L of the first portion R1 and/or the second portion R2 of the first surface 10S1 and the extension line S2L of the second surface 10S2. By the above design structure, the recess R has an accommodation space that can accommodate the electronic components. The extension line RBL of the bottom RB, the extension line S1L of the first portion R1 and/or the second portion R2 of the first surface 10S1, and the extension line S2L of the second surface 10S2 mentioned above are perpendicular to the Z direction. The side RS of the recess R is between the bottom RB and the first portion R1 and/or the second portion R2 of the first surface 10S1 and connects the bottom RB and the first portion R1 and/or the second portion R2 of the first surface 10S1. The recess R may have a recess depth T1 in the Z direction, and the recess depth T1 may be between 0.5 μm to 100 μm. The distance between the bottom RB of the recess R and the first portion R1 and/or the second portion R2 of the first surface 10S1 of the circuit structure 10 may be equal to the recess depth T1. In some embodiments, in a direction perpendicular to the Z-direction (e.g., the X-direction), the width of the bottom RB of the recess R is smaller than the width of the top of the recess R. That is, in some embodiments, in the cross-sectional view, the recess R may have an inverted trapezoidal shape, an inverted bowl shape, but the present disclosure is not limited thereto. Specifically, the recess R is a recessed space that can accommodate other components. In the embodiment, the angle θ between the side RS and the bottom RB of the recess R may be between 90° and 160° (90°≤0≤160°), between 105° and 155°, or between 110° and 145°, but the present disclosure is not limited thereto. The side RS has a top end RST and a bottom end RSB. The top end RST is between the side RS and the first portion R1 and/or the second portion R2 of the first surface 10S1 and the bottom end RSB is between the side RS and the bottom RB.

In some embodiments, any other desired electronic components 100 may be disposed on the first surface 10S1 of the circuit structure 10, as shown in FIG. 1A, but the present disclosure is not limited thereto. The electronic components 100 may include a surface mounted device (SMD), an integrated circuit chip, a diode, a driver circuit, a compensation circuit, an integrated passive device (IPD), or other suitable components, but the present disclosure is not limited thereto. In some embodiments, the electronic component 100 may further include a carrier substrate, such as a glass carrier substrate on which transistors are formed, an ABF carrier substrate on which chips are bonded, or other suitable electronic components.

The electronic component 30 disposed in the recess R may have a top surface 30T, a bottom surface 30B opposite the top surface 30T, and a side surface 30S connecting the top surface 30T and the bottom surface 30B. The top surface 30T may be, for example, a side of the electronic component 30 on which a conductive pad (I/O pad) is not provided, and the bottom surface 30B may be, for example, a side of the electronic component 30 on which a conductive pad (I/O pad) is provided. In some embodiments, the electronic component 30 may include a semiconductor chip, and the semiconductor chip may be, for example, a doped silicon chip, silicon carbide (SiC), gallium nitride (GaN), or other suitable semiconductor material, but the present disclosure is not limited thereto. The electronic component 30 may further include a passivation layer PL. In some embodiments, the passivation layer PL may be deposited on the bottom surface of the semiconductor chip. In some embodiments, the passivation layer PL may be disposed on the bottom surface 30B. In some embodiments, a portion of the passivation layer PL may be disposed between the bottom surface of the semiconductor chip and the conductive pad (I/O pad). The electronic component 30 has a height T2 in the Z-direction. The distance between the top surface 30T and the bottom surface 30B of the electronic component 30 may be equal to the height T2. In some embodiments, the height T2 may be between 5 μm and 200 μm. In some embodiments, a recess depth T1 of the recess R may be greater than or equal to the height T2 of the electronic component 30. In some embodiments, the height T2 of the electronic component 30 may be greater than the recess depth T1 of the recess R, but the present disclosure is not limited thereto. In some embodiments, the height T2 of the electronic component 30 and the recess depth T1 of the recess R conform to the following formula:

$$0.1 * the height T 2 ≦ the recess depth T 1 ≦ 0.5 * the height T 2.$$

In some embodiments, the top surface 30T of the electronic component 30 disposed in the recess R may be higher than the first surface 10S1 of the circuit structure 10 in the Z-direction, as shown in FIG. 1B. The above structure may reduce signal interference between components, but the present disclosure is not limited thereto.

A projection of the electronic component 30 on a plane (e.g., the XY plane) perpendicular to the normal direction of the electronic device is within a projection of the recess R on the plane. In the X-direction, the bottom end RSB of the side RS and an adjacent side surface 30S of the electronic component 30 are separated by a first distance D1, as shown in FIG. 1B. In some embodiments, the first distance D1 may be greater than or equal to 10 μm (≥10 μm) or between 10 μm and 20 μm. The phrase “an adjacent side surface 30S of the electronic component 30” in the expression “the bottom end RSB of the side RS and an adjacent side surface 30S of the electronic component 30” refers to the side surface 30S of the electronic component 30 that is closest to the bottom end RSB of the side RS. There is no other side surface 30S of the electronic component 30 between the bottom end RSB and the adjacent side surface 30S of the electronic component 30. In some embodiments, in the X-direction, the width of the electronic component 30 and the first distance D1 conform to the following formula:

$$The width of the electronic component 30 > the first distance D 1 ≧ 10 μ m .$$

By disposing the electronic component 30 in the recess R under the conditions described above, a risk of the electronic component 30 being hit or scratched when disposing the electronic component 30 can be reduced. By disposing the electronic component 30 in the recess R, a length of the lines in the first metal line layer 103, such as a length of the RF feed line and a height of the via in the Z-direction, can be shortened to reduce signal loss or offset or to reduce a delay of a signal transmission. In addition, by disposing the electronic component 30 in the recess R, a risk of the electronic component 30 being offset during manufacture, transport or use of the electronic device can also be reduced and the reliability of the electronic device can be increased.

In some embodiments, the electronic component 30 may include a surface mounted device (SMD), an integrated circuit chip, a diode, a driver circuit, a compensation circuit, an integrated passive device (IPD), a radio frequency integrated circuit (RFIC), or other suitable components, but the present disclosure is not limited thereto. In some embodiments, the electronic component 30 may be a radio frequency integrated circuit (RFIC). For example, the electronic component 30 may be a known good die containing a semiconductor structure, and the electronic component 30 may further include conductive pads for bonding the circuit structure 10, thereby electrically connecting the circuit structure 10. The conductive pads may include, but are not limited to, copper, tin, aluminum, gallium or other suitable conductive materials.

In some embodiments, the electronic device may further include a second bonding element 40 disposed between the electronic component 30 and the circuit structure 10. The electronic component 30 may be disposed in the recess R of the circuit structure 10 and electrically connected to the circuit structure 10 through the second bonding element 40. In some embodiments, the second bonding element 40 may be disposed between the bottom surface 30B of the electronic component 30 and the bottom RB of the recess R and electrically connect the electronic component 30 and the first metal line layer 103 of the circuit structure 10. A material of the second bonding element 40 may include copper (Cu), aluminum (Al), molybdenum (Mo), tungsten (W), gold (Au), chromium (Cr), nickel (Ni), platinum (Pt), titanium (Ti), silver (Ag), other suitable metal materials, or a combination of the foregoing, but the present disclosure is not limited thereto. According to some embodiments, a Cu pillar formed on the conductive pad (I/O pad) of the electronic component 30 and a Cu pillar formed on the circuit structure 10 are bonded together and define the second bonding element 40. The above bonding method may be referred to as Cu—Cu hybrid bonding.

In some embodiments, the electronic device may further comprise a buffer layer 60. The buffer layer 60 may be disposed between the electronic component 30 and the circuit structure 10 and surround the second bonding element 40. The buffer layer 60 may reduce a risk of oxidization of the second bonding element 40 and improve a mechanical strength between the electronic component 30 and the circuit structure 10. In some embodiments, a material of the buffer layer 60 may include an organic material, but the present disclosure is not limited thereto. Examples of the organic material may include an epoxy resin, an acrylic resin, or other suitable materials. In some embodiments, the buffer layer 60 may be, for example, an under fill. In some embodiments, the buffer layer 60 may include filler particles to improve a mechanical strength of the buffer layer 60 and improve the reliability of the electronic device. In some embodiments, a material of the buffer layer 60 may include an inorganic material. For example, in some embodiments, the buffer layer 60 may include a silicon oxide, a silicon nitride, or a stack including multiple silicon oxide layers and multiple silicon nitride layers stacked in the Z direction.

The antenna unit 50 is disposed on the first surface 10S1 of the circuit structure 10 and is electrically connected to the electronic component 30 through the circuit structure 10. According to some embodiments, the antenna unit 50 may be disposed corresponding to the first portion R1 of the first surface 10S1, the antenna unit 50 may be disposed corresponding to the second portion R2 of the first surface 10S1, or the antenna units 50 may be disposed at the first portion R1 and the second portion R2 respectively. When the electronic device includes a plurality of antenna units 50, at least two of the plurality of antenna units 50 may transmit or receive radio waves having different frequencies, but the present disclosure is not limited thereto. The antenna unit 50 may include a ring antenna, a broadband dipole antenna, a monopole antenna, a folded dipole antenna, a microstrip or patch antenna, a planar inverted F antenna (PIFA), an inverted F antenna (IFA), a Vivaldi antenna, a slotted waveguide antenna, a half-wave antenna, a quarter-wave antenna, a three-dimensional antenna, other suitable antennae, or any combination thereof, but the present disclosure is not limited thereto. By disposing the antenna unit 50 on the first surface 10S1 of the circuit structure 10, a heat generated by the electronic component 30 disposed in the recess R can be more easily dissipated and a heat dissipation effect of the electronic device can be improved. In some embodiments, the heat dissipation effect of the electronic device can be improved by more than 20%, but the present disclosure is not limited thereto.

The shielding layer 70 is formed on the circuit structure 10 and surrounds the electronic component 30. The shielding layer 70 can reduce a risk of radio frequency interference (RFI/EMI) between other signals and the electronic component 30, thereby improving a signal receiving sensitivity of the antenna unit 50. The shielding layer 70 may directly or indirectly contact the entire side surface 30S of the electronic component 30. In some embodiments, the shielding layer 70 may cover the entire side surface 30S and the entire top surface 30T of the electronic component 30, but the present disclosure is not limited thereto. In some embodiments, the shielding layer 70 may cover the entire side surface 30S of the electronic component 30 and expose at least a portion of the top surface 30T of the electronic component 30. In some embodiments, the shielding layer 70 may cover a portion of the bottom RB of the recess R and a portion of the first surface 10S1 of the circuit structure 10. Specifically, in some embodiments, the shielding layer 70 may cover a portion of the bottom RB of the recess R that does not overlap with the electronic component 30 in the Z-direction and a portion of the first surface 10S1. In some embodiments, the shielding layer 70 may directly or indirectly contact the side surface 30S and the top surface 30T of the electronic component 30, the side RS and the bottom RB of the recess R, and a portion of the first surface 10S1 connecting the recess R, as shown in FIG. 1B, but the present disclosure is not limited thereto. A projection of the electronic component 30 on a plane (e.g., the XY plane) perpendicular to the normal direction of the electronic device may be within a projection of the recess R on the plane, and the projection of the recess R on the plane may be within a projection of the shielding layer 70 on the plane, as shown in FIG. 1A. By the above design structure, in a plane (e.g., the XY plane) perpendicular to the normal direction of the electronic device, a projection area of the shielding layer 70 is larger than a projection area of the recess R on the plane. That is, the shielding layer 70 may cover a portion of the bottom RB of the recess R, the side RS of the recess R, and a portion of the first portion R1 and/or the second portion R2 of the first surface 10S1 connecting the recess R, thereby reducing the risk of radio frequency interference (RFI/EMI) between other signals and the electronic component 30, thereby improving a signal receiving sensitivity of the antenna unit 50, but the present disclosure is not limited thereto. In the Z-direction, a thickness of the shielding layer 70 on the first surface 10S1 of the circuit structure 10 may be approximately the same as a thickness of the shielding layer 70 on the top surface 30T of the electronic component 30 (a difference of no more than ±10%). The shielding layer 70 may have a side 70S. In some embodiments, the side 70S may be disposed on a first portion R1 and/or a second portion R2 of the first surface 10S1 of the circuit structure 10. In the embodiment, in a direction (e.g., the X-direction) perpendicular to the normal direction of the electronic device, the top end RST of the side RS and an adjacent side 70S of the shielding layer 70 may be separated by a second distance D2 as shown in FIG. 1A and FIG. 1B. That is, the width of the shielding layer 70 disposed on the first portion R1 and/or the second portion R2 of the first surface 10S1 of the circuit structure 10 may be regarded as the second distance D2. In some embodiments, the second distance D2 may be greater than or equal to 10 μm (≥10 μm) or between 10 μm and 100 μm. The phrase “an adjacent side 70S of the shielding layer 70” in the expression “the top end RST of the side RS and an adjacent side 70S of the shielding layer 70” refers to the side 70S of the shielding layer 70 that is closest to the side RS of the recess R. There is no other side 70S of the shielding layer 70 between the side RS of the recess R and the adjacent side 70S of the shielding layer 70.

The shielding layer 70 may include a single layer structure or a multi-layer structure. In some embodiments, the shielding layer 70 may include a multi-layer structure including a first sublayer 701, a second sublayer 703, and a third sublayer 705, wherein the second sublayer 703 is between the first sublayer 701 and the third sublayer 705, and the third sublayer 705 is between the second sublayer 703 and the electronic component 30, as shown in FIG. 1B, but the present disclosure is not limited thereto. In some embodiments, the shielding layer 70 may include a structure including more than three layers. In other embodiments, the shielding layer 70 may include a structure including less than three layers. The first sublayer 701, the second sublayer 703, and the third sublayer 705 may include different materials. In some embodiments, a material of the first sublayer 701 may include a material having good oxidation resistance, and a material of the second sublayer 703 and the third sublayer 705 may include a material having good radio frequency radiation shielding capability. In some embodiments, the material of the first sublayer 701 may include nickel (Ni), the material of the second sublayer 703 may include copper (Cu), and the material of the third sublayer 705 may include titanium (Ti), but the present disclosure is not limited thereto. In some embodiments, in the Z direction, the second sublayer 703 and the third sublayer 705 may have different thicknesses. In some embodiments, the second sublayer 703 may have a thickness of 0.6 μm and the third sublayer 705 may have a thickness of 0.1 μm, but the present disclosure is not limited thereto.

The electronic device of the present disclosure having the above structure may have a good heat dissipation effect, signal sensitivity, and/or system stability. According to some embodiments, by providing a shielding layer 70 covering the electronic component 30, wherein the width of the shielding layer 70 contacting the first surface 10S1 of the circuit structure 10 is between 10 μm and 30 μm, the electronic device can have a good signal sensitivity, or the bonding ability of the shielding layer 70 and the circuit structure 10 can be improved.

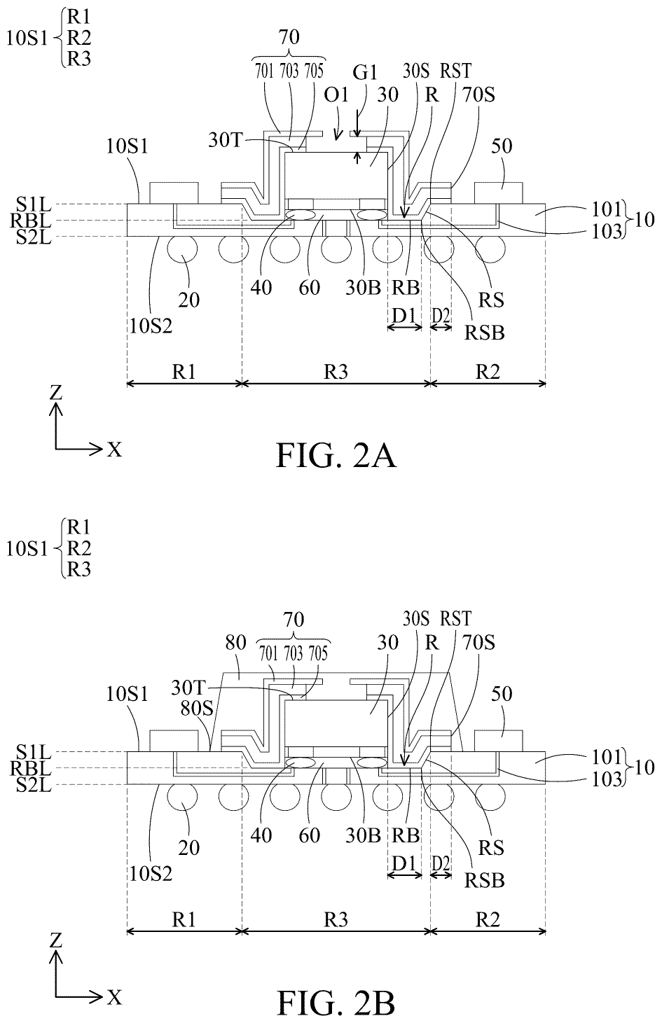

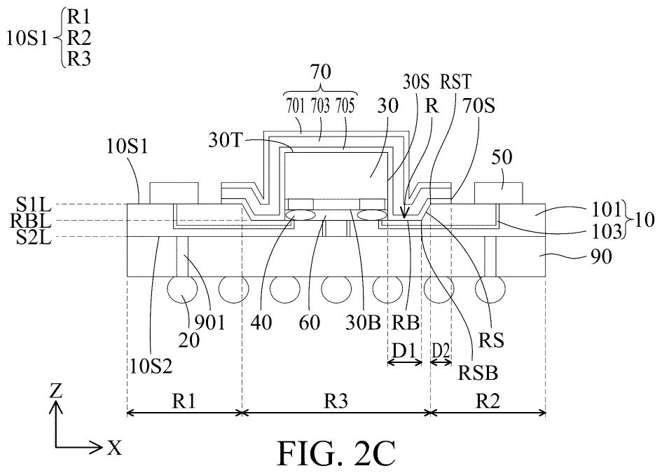

FIG. 2A is a cross-sectional schematic view of an electronic device according to another embodiment of the present disclosure. In the embodiment, the shielding layer 70 surrounding the electronic component 30 has an opening O1, and a portion of the top surface 30T of the electronic component 30 may be exposed through the opening O1 as shown in FIG. 2A. The shielding layer 70 having the openings O1 may be used together with the electronic component 30 as another antenna unit for receiving or transmitting signals having a different bandwidth from that of the antenna unit 50. In embodiments that the shielding layer 70 includes a first sublayer 701, a second sublayer 703, and a third sublayer 705, the opening O1 is defined by a first opening in the first sublayer 701, a second opening in the second sublayer 703, and a third opening in the third sublayer 705. In some embodiments, in a direction (e.g., the X-direction) perpendicular to the normal direction of the electronic device, the width of the second opening may be approximately equal to the width of the third opening. In some embodiments, in a direction (e.g., the X-direction) perpendicular to the normal direction of the electronic device, the width of the second opening and/or the third opening may be greater than the width of the first opening. In the embodiment, there may be a first gap G1 between the first sublayer 701 and the electronic component 30. Specifically, a first gap G1 may be between the bottom surface of the first sublayer 701 and the top surface 30T of the electronic component 30. In some embodiments, the first gap G1 may be between 0.1 μm and 1 μm or 0.2 μm and 0.8 μm, but the present disclosure is not limited thereto.

With the exception of the shielding layer 70 having an opening O1, the structure of the electronic device shown in FIG. 2A is substantially the same as that of the electronic device shown in FIG. 1A and FIG. 1B, and will therefore not be repeated herein.

FIG. 2B is a cross-sectional schematic view of an electronic device according to another embodiment of the present disclosure. In the embodiment, the electronic device of the present disclosure may further include a protective layer 80, the protective layer 80 may surround and cover the shielding layer 70 and the electronic component 30, thereby reducing a risk of the electronic component 30 and the shielding layer 70 being affected by moisture and oxygen in the environment. In some embodiments, the protective layer 80 may directly or indirectly contact the shielding layer 70 and the electronic component 30, as shown in FIG. 2B, but the present disclosure is not limited thereto. In the embodiment, a projection of the shielding layer 70 in a plane (e.g., the XY plane) perpendicular to the normal direction of the electronic device is within a projection of the protective layer 80 on the plane, and a projection of the electronic component 30 on the plane is within the projection of the shielding layer 70 on the plane. In embodiments that the shielding layer 70 has an opening O1, the protective layer 80 may be filled into the opening O1 of the shielding layer 70 and directly contact a portion of the top surface 30T of the electronic component 30 exposed through the opening O1, but the present disclosure is not limited thereto. A material of the protective layer 80 may include an epoxy resin, an acrylic resin, other suitable materials, or any combination thereof, but the present disclosure is not limited thereto. According to some embodiments, the protective layer 80 has a dielectric loss of less than or equal to 0.05, i.e., Df(@10 GHz)≤0.05.

With the exception that the electronic device further includes the protective layer 80, the structure of the electronic device shown in FIG. 2B is substantially the same as that of the electronic device shown in FIG. 2A and will therefore not be repeated herein.

FIG. 2C is a cross-sectional schematic view of an electronic device according to another embodiment of the present disclosure. In the embodiment, the electronic device of the present disclosure may further include a substrate 90. The substrate 90 may be disposed between the circuit structure 10 and the first bonding element 20. The substrate 90 may include a second metal line layer 901. The second metal line layer 901 may include metal lines and/or vias. The second metal line layer 901 may include a single layer or a multi-layer structure. In embodiments that the second metal line layer 901 includes multiple second metal line layers 901, the second metal line layers 901 may be electrically connected to each other. The circuit structure 10 may electrically connects the first bonding element 20 through the second metal line layer 901. The substrate 90 may improve a support of the electronic device or improve the design flexibility of lines and components in the electronic device. A material of the second metal line layer 901 may include a seed layer, a metal, or any combination thereof. In some embodiments, examples of the metal may include copper (Cu), aluminum (Al), molybdenum (Mo), tungsten (W), gold (Au), chromium (Cr), nickel (Ni), platinum (Pt), titanium (Ti), other suitable metal materials, or combinations of the foregoing, but the present disclosure is not limited thereto. The substrate 90 may include a silicon substrate, a glass substrate, an ABF substrate, an FR-4 substrate, a ceramic substrate, or other suitable substrates, but the present disclosure is not limited thereto. A thickness of the substrate 90 may be greater than a thickness of the circuit structure 10, or a rigidity of the substrate 90 may be greater than a rigidity of the circuit structure 10, so that the substrate 90 can carry more components and improve the mechanical strength of the electronic device, but the present disclosure is not limited thereto.

With the exception that the substrate 90 is further included between the circuit structure 10 and the first bonding element 20, the structure of the electronic device shown in FIG. 2C is substantially the same as that of the electronic device shown in FIG. 1A and FIG. 1B and will therefore not be repeated herein.

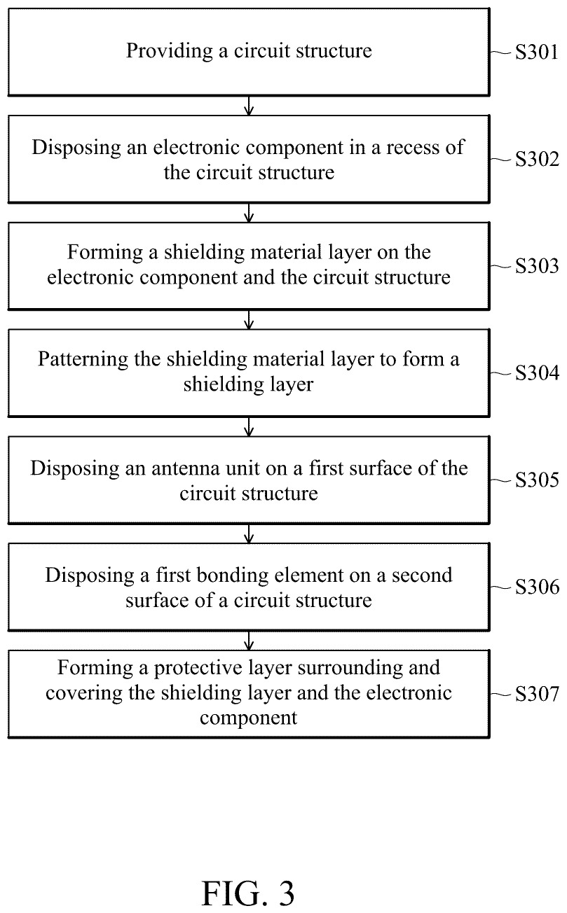

Another aspect of the present disclosure provides a method of manufacturing an electronic device. FIG. 3 is a flowchart of the method of manufacturing the electronic device according to an embodiment of the present disclosure. As shown in FIG. 3, the method of manufacturing the electronic device of the present disclosure includes the step S301 of providing a circuit structure, wherein the circuit structure has a first surface and a second surface opposite the first surface. The first surface has a first portion, a second portion, and a third portion. The third portion connects the first portion to the second portion. The third portion is closer to the second surface than the first portion and the second portion in the normal direction of the electronic device, thereby forming a recess. The method includes the step S302 of disposing an electronic component in the recess of the circuit structure. The electronic component is electrically connected to the circuit structure. The method includes the step S303 of forming a shielding material layer on the electronic component and the circuit structure. The shielding material layer conformally covers the electronic component and the circuit structure. The method includes the step S304 of patterning the shielding material layer to form a shielding layer. The shielding layer surrounds the electronic component. The method includes the step S305 of disposing an antenna unit on the first surface of the circuit structure. The antenna unit is electrically connected to the electronic component through the circuit structure.

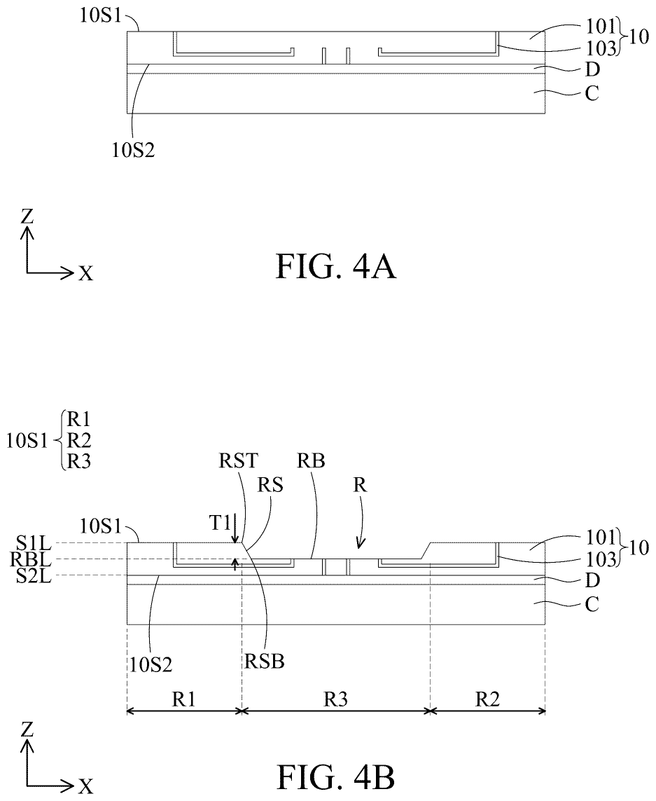

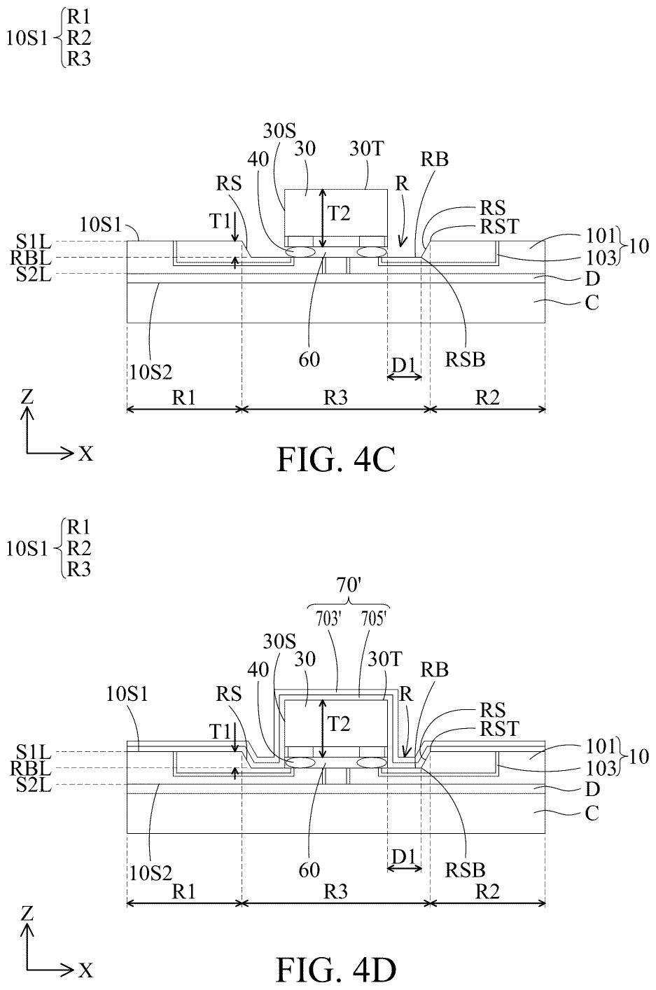

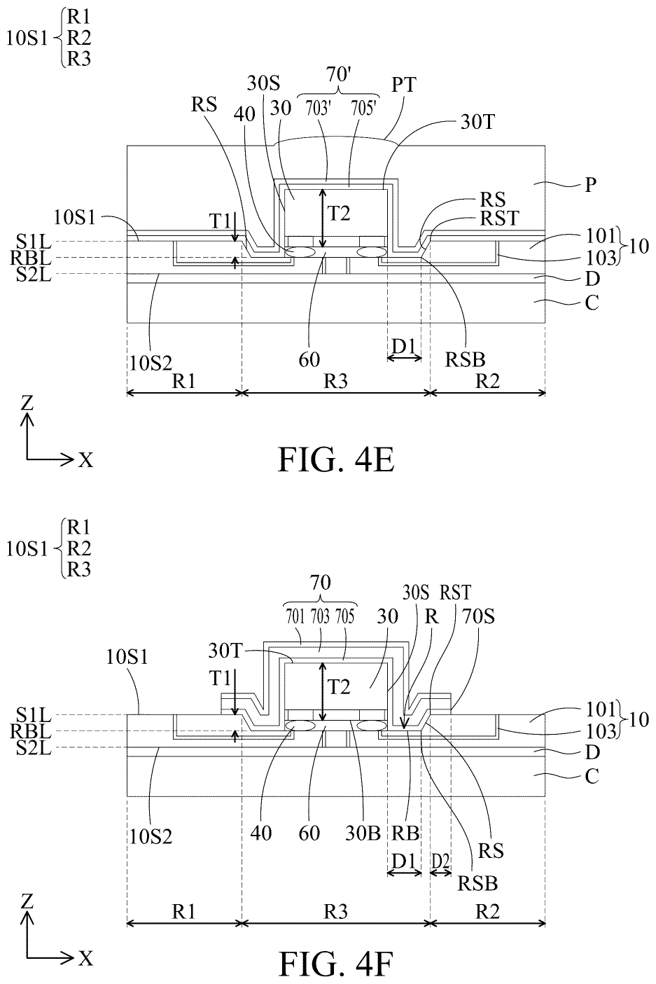

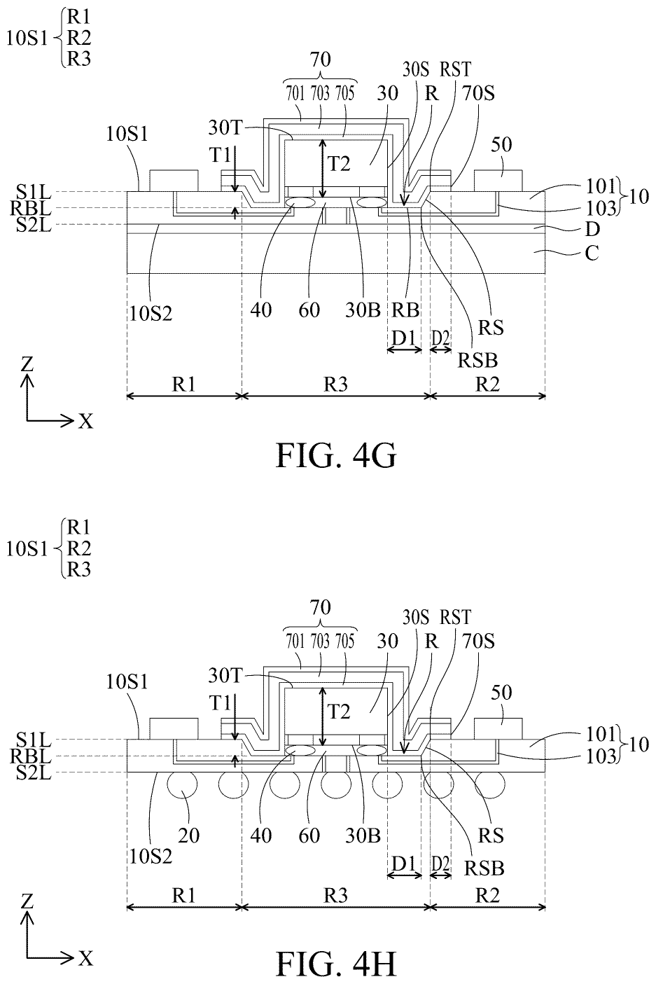

FIGS. 4A to 4H are cross-sectional schematic views of an electronic device during manufacturing according to an embodiment of the present disclosure. The method of manufacturing the electronic device according to an embodiment of the present disclosure is further described below with reference to FIG. 3 and FIGS. 4A to 4H.

Step S301 may include forming a recess R in a circuit structure 10 after providing the circuit structure 10 on a carrier substrate C on which a release layer D is disposed, but the present disclosure is not limited thereto. In some embodiments, the circuit structure 10 of step S301 may be provided on a substrate. FIGS. 4A to 4G illustrate embodiments in which the circuit structure 10 is provided on a carrier substrate C on which a release layer D is disposed. In some embodiments, the circuit structure 10 may be provided on the carrier substrate C so that the second surface 10S2 is between the first surface 10S1 and the release layer D, as shown in FIG. 4A. An embodiment in which the circuit structure 10 may include an insulating layer 101 and a first metal line layer 103 disposed on or in the insulating layer 101 is used as an example to illustrate the present disclosure in the following. The first metal line layer 103 may include an RF feed line, a redistribution line, and/or a via. According to some embodiments, the release layer D may not be disposed on the carrier substrate C, i.e., the circuit structure 10 may be disposed directly on the carrier substrate C, and thus the carrier substrate C may include, for example, a substrate 90.

The circuit structure 10 may have a first surface 10S1 and a second surface 10S2 opposite the first surface 10S1. The first surface 10S1 has a first portion R1, a second portion R2, and a third portion R3, and the third portion R3 connects the first portion R1 and the second portion R2. In the normal direction of the electronic device (Z-direction), the third portion R3 is closer to the second surface 10S2 than the first portion R1 and the second portion R2, thereby forming a recess R. In some embodiments, the recess R may be formed by a plasma etching process, a laser etching process, a chemical etching process, a photolithography process, other suitable patterning process, or any combination thereof, but the present disclosure is not limited thereto. In the process of performing the patterning step on the circuit structure 10 to form the recess R, the patterning step may be performed until at least a portion of the first metal line layer 103 in the insulating layer 101 is exposed for subsequent electrical connection steps, but the present disclosure is not limited thereto. The recess R may have a bottom RB and a side RS surrounding the bottom RB. The bottom RB of the recess R may be between a first portion R1 and/or a second portion R2 of the first surface 10S1 and the second surface 10S2. The side RS of the recess R may be between the bottom RB and the first portion R1 and/or the second portion R2 of the first surface 10S1 and connect the bottom RB and the first portion R1 and/or the second portion R2 of the first surface 10S1. The side RS has a top end RST and a bottom end RSB. The top end RST is between the side RS and the first portion R1 and/or the second portion R2 of the first surface 10S1 and the bottom end RSB is between the side RS and the bottom RB. In some embodiments, the distance between the top end RST of the side RS and the first metal line layer 103 of the circuit structure 10 is greater than or equal to 10 μm (≥10 μm), but the present disclosure is not limited thereto. The recess R may have a recess depth T1 in the Z-direction. The distance between the bottom RB of the recess R and the first portion R1 and/or the second portion R2 of the first surface 10S1 of the circuit structure 10 may be equal to the recess depth T1. In some embodiments, in a direction perpendicular to the Z-direction (e.g., the X-direction), the width of the bottom RB of the recess R may be smaller than the width of the top of the recess R. That is, in some embodiments, the recess R has an inverted trapezoidal shape in the cross-sectional view. In this embodiment, the angle between the side RS and the bottom RB of the recess R may be between 90° and 160°, between 105° and 155°, or between 110° and 145°, but the present disclosure is not limited thereto.

In step S302, the second bonding element 40 may be disposed on the bottom RB of the recess R and may be disposed between the bottom surface 30B of the electronic component 30 and the bottom RB of the recess R. Methods of forming the second bonding element 40 include ball dropping, electroplating, plating, deposition, printing, pressurized heating or other suitable methods. The electronic component 30 may be disposed on the bottom RB of the recess R of the circuit structure 10 by the second bonding element 40 and electrically connected to the first metal line layer 103 of the circuit structure 10 by the second bonding element 40. According to some embodiments, a Cu pillar formed on a conductive pad of the electronic component 30 and a Cu pillar formed on the circuit structure 10 are bonded together and define the second bonding element 40. The above bonding method may be referred to as Cu—Cu hybrid bonding. In some embodiments, step S302 may further include providing a buffer layer 60 disposed between the electronic component 30 and the circuit structure 10 and surrounding the second bonding element 40 to reduce a risk of oxidation of the second bonding element 40 and to improve a mechanical strength between the electronic component 30 and the circuit structure 10 as shown in FIG. 4C, but the present disclosure is not limited thereto. In some embodiments, the buffer layer 60 may be omitted.

The electronic component 30 in step S302 may have a top surface 30T, a bottom surface 30B opposite the top surface 30T, and a side surface 30S connecting the top surface 30T and the bottom surface 30B. In the Z-direction, the electronic component 30 may have a height T2. In some embodiments, the height T2 may between 5 μm and 200 μm. In some embodiments, the recess depth T1 of the recess R may be greater than or equal to the height T2 of the electronic component 30. In some embodiments, the height T2 of the electronic component 30 may be greater than the recess depth T1 of the recess R, but the present disclosure is not limited thereto. In some embodiments, the height T2 of the electronic component 30 and the recess depth T1 of the recess R conform to the following formula:

$$0.1 * the height T 2 ≦ the recess depth T 1 ≦ 0.5 * the height T 2.$$

The top surface 30T of the electronic component 30 disposed in the recess R may be higher than an extension line S1L of the first surface 10S1 of the circuit structure 10. That is, in the Z direction, the top surface 30T of the electronic component 30 is between the extension line S1L of the first surface 10S1 of the circuit structure 10 and the bottom surface 30B, as shown in FIG. 4C. According to some embodiments, the bottom surface 30B of the electronic component 30 may be lower than the first surface 10S1 of the circuit structure 10, i.e., in the Z-direction, the extension line S1L of the first surface 10S1 of the circuit structure 10 is between the top surface 30T and the bottom surface 30B of the electronic component 30.

In step S302, the electronic component 30 may be disposed in the recess R such that a first distance D1 between the side surface 30S and an edge of the bottom RB of the side RS in a direction perpendicular to the Z-direction (e.g., in the X-direction), as shown in FIG. 4C. In some embodiments, the first distance D1 may be greater than or equal to 10 μm (≥10 μm) or between 10 μm and 100 μm. By disposing the electronic component 30 in the recess R with the above conditions, a risk of the electronic component 30 being hit or scratched when disposing the electronic component 30 can be reduced. By disposing the electronic component 30 in the recess R, a length of the RF feed line and a height of the via in the Z-direction in the first metal line layer 103 can be shortened to reduce signal loss or offset or to reduce a delay of a signal transmission. In addition, by disposing the electronic component 30 in the recess R, a risk of the electronic component 30 being offset during manufacture, transport or use of the electronic device can also be reduced and the reliability of the electronic device can be increased.

In step S303, a shielding material layer 70′ may be formed on the electronic component 30 and the circuit structure 10 by a plating process, a chemical plating process, a sputtering process, another suitable process, or any combination thereof. Specifically, the shielding material layer 70′ may cover and contact the entire first surface 10S1 of the circuit structure 10, the top surface 30T and the side surfaces 30S of the electronic component 30, the side RS of the recess R, and the bottom RB of the recess R that does not overlap with the electronic component 30 in the Z-direction as shown in FIG. 4D. In some embodiments, the shielding material layer 70′ may include a first material sublayer 703′ and a second material sublayer 705′, wherein the second material sublayer 705′ may be between the first material sublayer 703′ and the electronic component 30, but the present disclosure is not limited thereto. A material of the first material sublayer 703′ and the second material sublayer 705′ may include a material having good radio frequency radiation shielding capability. The first material sublayer 703′ and the second material sublayer 705′ may include different materials. In some embodiments, the material of the first material sublayer 703′ may include copper (Cu), and the material of the second material sublayer 705′ may include titanium (Ti), but the present disclosure is not limited thereto. In some embodiments, in the Z direction, the first material sublayer 703′ and the second material sublayer 705′ may have different thicknesses. In some embodiments, the first material sublayer 703′ may have a thickness of 0.6 μm and the second material sublayer 705′ may have a thickness of 0.1 μm, but the present disclosure is not limited thereto.

In step S304, the shielding material layer 70′ formed in step S303 may be patterned to form the shielding layer 70. In some embodiments, step S304 may include a patterning process for patterning the shielding material layer 70′, and a shielding sublayer formation process for forming a first sublayer 701 on the patterned shielding material layer 70′ to form the shielding layer 70.

The patterning process may include a photoresist formation process, a photoresist patterning process, an etching process, and a photoresist removal process. The photoresist formation process may include forming a photoresist layer P on the shielding material layer 70′ using a dry film process and/or a wet film process. In some embodiments, the photoresist layer P is conformally formed on the shielding material layer 70′ and covers the entire shielding material layer 70′ to reduce an effect of subsequent processes on a quality of components under the photoresist layer P, but the present disclosure is not limited thereto. In particular, a portion of the top surface PT of the photoresist layer P corresponding to the electronic component 30 may protrude from the other portion of the top surface PT of the photoresist layer P as shown in FIG. 4E, but the present disclosure is not limited thereto. In some embodiments, a portion of the top surface PT of the photoresist layer P corresponding to the electronic component 30 may be flush with the other portion of the top surface PT of the photoresist layer P.

The photoresist layer P may be patterned by the photoresist patterning process. The photoresist patterning process may include an exposure/development process. In a direction (e.g., the X-direction) perpendicular to the Z-direction, an edge (not shown) of the patterned photoresist layer P may be separated by a second distance D2 from the top end RST of the side RS of the recess R. In some embodiments, the second distance D2 is greater than or equal to 10 μm (≥10 μm) or between 10 μm and 100 μm.

The etching process and the photoresist removal process may include a wet etching process and/or a dry etching process. The patterned photoresist layer P may be used as a mask during the etching process, and the photoresist removal process may remove the patterned photoresist layer P. The shielding material layer 70′ covered by the patterned photoresist layer P may be formed into a patterned shielding material layer 70′ after the etching process and the photoresist removal process. In embodiments that the shielding material layer 70′ includes a first material sublayer 703′ and a second material sublayer 705′, the patterned shielding material layer 70′ may include a second sublayer 703 and a third sublayer 705, and the shielding material layer 70′ that is not covered by the patterned photoresist layer P may be left with only the second material sublayer 705′ after the etching process and the photoresist removal process.

In the shielding sublayer formation process, the first sublayer 701 may be formed on the patterned shielding material layer 70′ by an electroplating process, a chemical plating process, a sputtering process, other suitable process, or any combination thereof to form the shielding layer 70 including the first sublayer 701, the second sublayer 703, and the third sublayer 705 as shown in FIG. 4F, but the present disclosure is not limited thereto. Specifically, after the etching process and the photoresist removal process, the shielding material layer 70′ that is not covered by the patterned photoresist layer P and the patterned shielding material layer 70′ will include different materials, and the first sublayer 701 is selectively formed only on the patterned shielding material layer 70′.

The shielding layer 70 formed in step S304 may surround the electronic component 30 and fill the recess R of the circuit structure 10. Specifically, a projection of the electronic component 30 and the recess R on a plane (e.g., the XY plane) perpendicular to the normal direction of the electronic device may be within a projection of the shielding layer 70 on the plane. In the embodiment, in a direction (e.g., the X-direction) perpendicular to the normal direction of the electronic device, the top end RST of the side RS of the recess R and an adjacent side 70S of the shielding layer 70 may be separated by a second distance D2 as shown in FIG. 4F. In some embodiments, the second distance D2 is greater than or equal to 10 μm (≥10 μm) or between 10 μm and 100 μm.

In step S305, the antenna unit 50 is formed on the first surface 10S1 of the circuit structure 10 and electrically connects to the electronic component 30 through the circuit structure 10, and the resulting structure is shown in FIG. 4G. The electronic device of the present disclosure may be obtained after removing the carrier substrate C from the structure as shown in FIG. 4G, but the present disclosure is not limited thereto. In the embodiment that the circuit structure 10 is provided on a substrate at step S301, the electronic device of the present disclosure may be obtained directly after step S305 without removing the substrate under the circuit structure 10. The method of removing the carrier substrate C includes degrading the release layer D by heating or illuminating the release layer D so that the circuit structure 10 or other components can be separated from the carrier substrate C.

In some embodiments, the method of manufacturing the electronic device of the present disclosure may further include: a step S306 of disposing a first bonding element on a second surface of a circuit structure, wherein the first bonding element electrically connects to the electronic component; and a step S307 of forming a protective layer surrounding and covering the shielding layer and the electronic component as shown in FIG. 3, but the present disclosure is not limited thereto. In some embodiments, one of steps S306 and S307 or a combination thereof may be omitted. In some embodiments, steps S306 and S307 may be performed sequentially, but the present disclosure is not limited thereto. In some embodiments, step S307 may be performed before step S306.

Step S306 may be performed after step S305. Step S306 may include disposing a first bonding element 20 on the second surface 10S2 of the circuit structure 10 after removing the carrier substrate C from the structure as shown in FIG. 4G. More specifically, after removal of the carrier substrate C, a portion of the first metal line layer 103 may be exposed. The exposed first metal line layer 103 may be regarded as an under-bump metallization (UBM), which may be used to bond to the first bonding element 20. According to some embodiments, in the embodiment that the carrier substrate C is not to be removed, the carrier substrate C can be considered as a substrate 90 of the electronic device. The substrate 90 may be between the first bonding element 20 and the electronic component 30 and may electrically connect the first bonding element 20 and the electronic component 30. In particular, the first bonding element 20 and the electronic component 30 may be disposed on opposite sides of the substrate 90 and electrically connected to each other by a second metal line layer 901 in the substrate 90, as shown in FIG. 2C, but the present disclosure is not limited thereto. In some embodiments, the substrate 90 may be omitted, and an electronic device with the substrate 90 omitted has a structure as shown in FIG. 4H.

The step S307 of forming the protective layer 80 may be performed before or after the step S306. The step S307 of forming the protective layer 80 may include molding, laminating, coating, depositing or other suitable processes as long as the purpose of protecting the electronic components 30 and the shielding layer 70 can be achieved without affecting a signal receiving sensitivity of the antenna unit 50. The protective layer 80 may be formed by any suitable process.

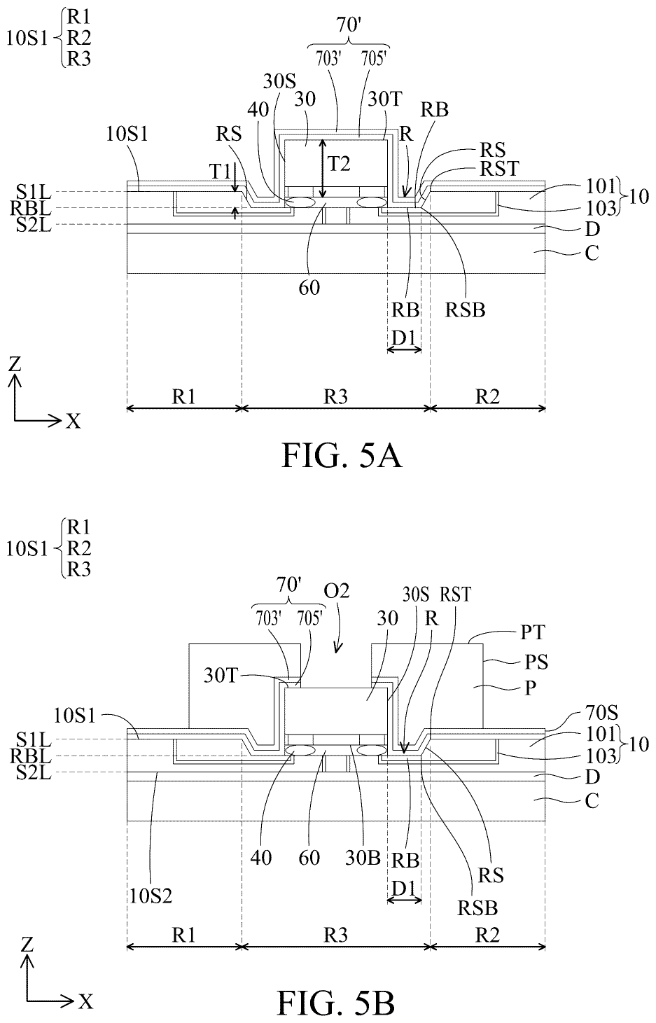

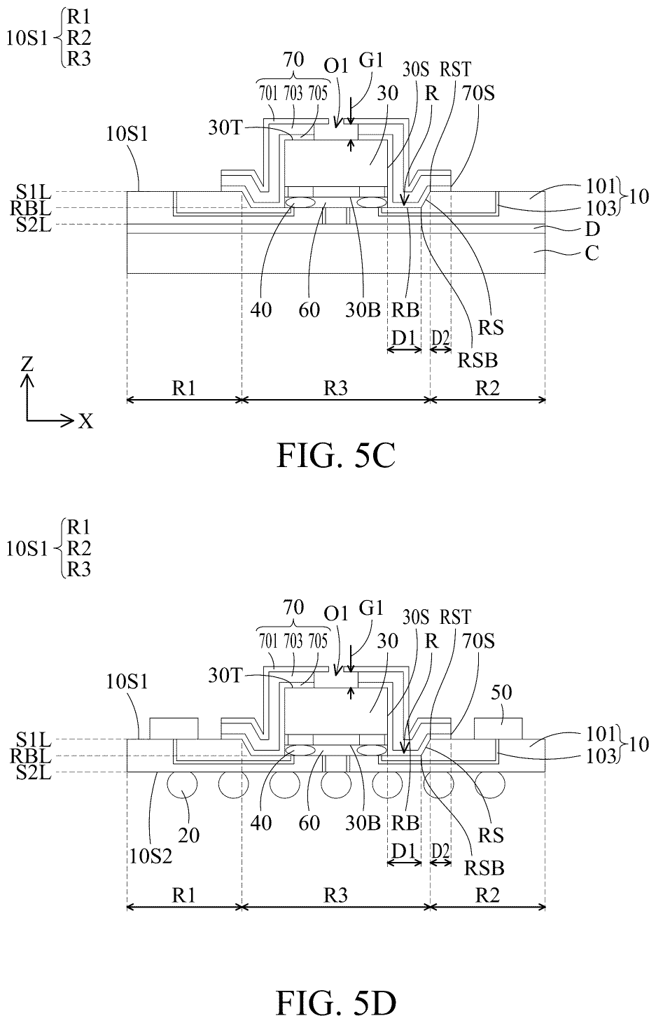

FIGS. 5A to 5D are cross-sectional schematic views of an electronic device during manufacturing according to another embodiment of the present disclosure. Steps S301 to S303 in the embodiment are the same as those described with reference to FIGS. 4A to 4D, and FIG. 5A is a cross-sectional schematic view of the electronic device obtained after step S303 of the method of manufacturing the electronic device shown in FIG. 3, which is substantially the same as the structure shown in FIG. 4D, and therefore will not be repeated herein. Steps S304 to S307 of the method of manufacturing the electronic device according to another embodiment of the present disclosure are further described below with reference to FIG. 3 and FIGS. 5A to 5D.

In step S304, the shielding material layer 70′ formed in step S303 may be patterned to form a shielding layer 70 having an opening O1. In some embodiments, step S304 may include a patterning process for patterning the shielding material layer 70′, and a shielding sublayer formation process for forming a first sublayer 701 on the patterned shielding material layer 70′ to form the shielding layer 70 having an opening O1.

The patterning process may include a photoresist formation process, a photoresist patterning process, an etching process, and a photoresist removal process. The photoresist formation process may include forming the photoresist layer P on the shielding material layer 70′ using a dry film process and/or a wet film process. In some embodiments, the photoresist layer P is conformally formed on the shielding material layer 70′ and covers the entire shielding material layer 70′ to reduce an effect of subsequent processes on a quality of the component under the photoresist layer P, but the present disclosure is not limited thereto. In particular, a portion of the top surface PT of the photoresist layer P corresponding to the electronic component 30 may protrude from the other portion of the top surface PT of the photoresist layer P as shown in FIG. 4E, but the present disclosure is not limited thereto. In some embodiments, a portion of the top surface PT of the photoresist layer P corresponding to the electronic component 30 may be flush with the other portion of the top surface PT of the photoresist layer P. The phrase “A conformally formed on B” used herein indicates that A having a surface formed on a surface of B, the surface of A is away from the surface of B, and the surface of A and the surface of B have the same topographical features.

The photoresist layer P may be patterned by the photoresist patterning process. The photoresist patterning process may include an exposure/development process. The patterned photoresist layer P may have an opening O2. The opening O2 may expose a portion of the shielding material layer 70′ disposed on the top surface 30T of the electronic component 30, as shown in FIG. 5B. According to some embodiments, each sublayer of the shielding material layer 70′ may be sequentially patterned by multiple patterning processes to form a shielding layer 70 having an opening O1. According to some embodiments, each sublayer of the patterned shielding material layer 70′ may be patterned by a single patterning process to form a shielding layer 70 having an opening O1. In a direction (e.g., the X-direction) perpendicular to the Z-direction, a side PS of the patterned photoresist layer P may be separated by a second distance D2 from the top end RST of the side RS of the recess R. In some embodiments, the second distance D2 is greater than or equal to 10 μm (≥10 μm) or between 10 μm and 100 μm.

The etching process and the photoresist removal process may include a wet etching process and/or a dry etching process. The patterned photoresist layer P may be used as a mask during the etching process, and the photoresist removal process may remove the patterned photoresist layer P. The shielding material layer 70′ covered by the patterned photoresist layer P may be formed into a patterned shielding material layer 70′ after the etching process and the photoresist removal process. In embodiments that the shielding material layer 70′ includes a first material sublayer 703′ and a second material sublayer 705′, the patterned shielding material layer 70′ may include a second sublayer 703 and a third sublayer 705, and the shielding material layer 70′ that is not covered by the patterned photoresist layer P may be left with only the second material sublayer 705′ after the etching process and the photoresist removal process. That is, the patterned shielding material layer 70′ may include a material layer opening corresponding to the opening O2. The second material sublayer 705′ is disposed in the material layer opening.

In the shielding sublayer formation process, the first sublayer 701 may be formed on the patterned shielding material layer 70′ by an electroplating process, a chemical plating process, a sputtering process, other suitable process, or any combination thereof to form the shielding layer 70 including the first sublayer 701, the second sublayer 703, and the third sublayer 705 as shown in FIG. 5C, but the present disclosure is not limited thereto. In some embodiments, there is a first gap G1 between the first sublayer 701 of the shielding layer 70 and the electronic component 30 as shown in FIG. 5C. Specifically, there is a first gap G1 between the bottom surface of the first sublayer 701 and the top surface 30T of the electronic component 30. In some embodiments, the first gap G1 may be between 0.1 μm and 0.5 μm, but the disclosure is not limited thereto.

The shielding layer 70 formed in step S304 may surround the electronic component 30 and fill the recess R of the circuit structure 10. Specifically, a projection of the electronic component 30 and the recess R on a plane (e.g., the XY plane) perpendicular to the normal direction of the electronic device may be within a projection of the shielding layer 70 on the plane. In the embodiment, in a direction (e.g., the X-direction) perpendicular to the normal direction of the electronic device, the top end RST of the side RS of the recess R and an adjacent side 70S of the shielding layer 70 may be separated by a second distance D2 as shown in FIG. 5C. In some embodiments, the second distance D2 is greater than or equal to 10 μm (≥10 μm) or between 10 μm and 100 μm.

In step S305, the antenna unit 50 is formed on the first surface 10S1 of the circuit structure 10 and electrically connects to the electronic component 30 through the circuit structure 10, and the resulting structure is shown in FIG. 5D. The electronic device of the present disclosure may be obtained after removing the carrier substrate C from the structure as shown in FIG. 5D, but the present disclosure is not limited thereto. In the embodiment that the circuit structure 10 is provided on a substrate at step S301, the electronic device of the present disclosure may be obtained directly after step S305 without removing the substrate under the circuit structure 10.

In some embodiments, the method of manufacturing the electronic device of the present disclosure may further include: a step S306 of disposing a first bonding element on a second surface of a circuit structure, wherein the first bonding element electrically connects to the electronic component; and a step S307 of forming a protective layer surrounding and covering the shielding layer and the electronic component as shown in FIG. 3, but the present disclosure is not limited thereto. In some embodiments, one of steps S306 and S307 or a combination thereof may be omitted. In some embodiments, steps S306 and S307 may be performed sequentially, but the present disclosure is not limited thereto. In some embodiments, step S307 may be performed before step S306.

Step S306 may be performed after step S305. Step S306 may include disposing a first bonding element 20 on the second surface 10S2 of the circuit structure 10 after removing the carrier substrate C from the structure as shown in FIG. 5D. More specifically, after removal of the carrier substrate C, a portion of the first metal line layer 103 may be exposed. The exposed first metal line layer 103 may be regarded as an under-bump metallization (UBM), which may be used to bond to the first bonding element 20. According to some embodiments, in the embodiment that the carrier substrate C is not to be removed, the carrier substrate C can be considered as a substrate 90 of the electronic device. The substrate 90 may be between the first bonding element 20 and the electronic component 30 and may electrically connect the first bonding element 20 and the electronic component 30. In particular, the first bonding element 20 and the electronic component 30 may be disposed on opposite sides of the substrate 90 and electrically connected to each other by a second metal line layer 901 in the substrate 90, but the present disclosure is not limited thereto. In some embodiments, the substrate 90 may be omitted, and an electronic device with the substrate 90 omitted has a structure as shown in FIG. 5D.

The step S307 of forming the protective layer 80 may be performed before or after the step S306. There is no specific limitation to step S307 of forming the protective layer 80 as long as the purpose of protecting the electronic components 30 and the shielding layer 70 can be achieved without affecting a signal receiving sensitivity of the antenna unit 50. The protective layer 80 may be formed by any suitable process.

The electronic device manufactured according to the above method of manufacturing the electronic device of the disclosure includes an electronic component disposed in a recess of a circuit structure, and the electronic component may be disposed on the same side of the circuit structure as an antenna unit. As a result, the electronic device manufactured according to the above method of manufacturing the electronic device of the disclosure may have better heat dissipation effect and/or reliability. In addition, when the electronic device of the present disclosure is used in an apparatus for transmitting or receiving radio waves, the electronic device having the above design can improve the signal receiving sensitivity, so that the electronic device has a strong directivity and good efficiency, but the present disclosure is not limited thereto.

Although embodiments of the present disclosure and the advantages thereof have been disclosed as above, it should be understood that changes, substitutions and modifications may be made without departing from the spirit and scope of the disclosure. In addition, the protection scope of the present disclosure is not limited to the processes, machines, fabrications, compositions, devices, methods and steps in the specific embodiments described in the specification. According to the embodiments of the present disclosure, a person of ordinary skill in the art may understand that current or future processes, machines, fabrications, compositions, devices, methods and steps capable of performing substantially the same functions or achieving substantially the same results may be used in the embodiments of the present disclosure. Therefore, the protection scope of the present disclosure includes the above-mentioned processes, machines, fabrications, compositions, devices, methods and steps. In addition, each of the claims constitutes an individual embodiment, and the protection scope of the present disclosure also includes a combination of each claim and embodiment. As long as the features of each of the embodiments do not violate the spirit of the invention or conflict with each other, they can be mixed and matched arbitrarily.

What is claimed is:

1. An electronic device, comprising:
a circuit structure having a first surface and a second surface opposite the first surface, wherein the first surface has a first portion, a second portion, and a third portion, the third portion connects the first portion and the second portion, in a normal direction of the electronic device, the first portion and the second portion are farther away from the second surface than the third portion, thereby forming a recess;
an electronic component disposed in the recess, wherein the electronic component is electrically connected to the circuit structure;
an antenna unit disposed corresponding on at least one of the first portion and the second portion of the first surface of the circuit structure, wherein the antenna unit is electrically connected to the electronic component through the circuit structure; and
a shielding layer surrounding the electronic component.

2. The electronic device as claimed in claim 1, wherein the recess has a bottom and a side connecting the bottom, and from a cross-sectional view, an angle between the side and the bottom of the recess is between 90° and 160°.

3. The electronic device as claimed in claim 2, wherein the shielding layer is in contact with the side of the recess.

4. The electronic device as claimed in claim 1, further comprising a first bonding element disposed on the second surface of the circuit structure and electrically connected to the electronic component.

5. The electronic device as claimed in claim 4, further comprising a substrate, the substrate comprising a second metal line layer and disposed between the circuit structure and the first bonding element, wherein the circuit structure electrically connects the first bonding element through the second metal line layer.

6. The electronic device as claimed in claim 1, further comprising a second bonding element disposed between the electronic component and the circuit structure, wherein the second bonding element electrically connects the electronic component to the circuit structure through the second bonding element.

7. The electronic device as claimed in claim 6, further comprising a buffer layer disposed between the electronic component and the circuit structure and surrounding the second bonding element.

8. The electronic device as claimed in claim 1, wherein the shielding layer has an opening, and a portion of the top surface of the electronic component is exposed through the opening.

9. The electronic device as claimed in claim 1, wherein the shielding layer comprises a first sublayer, a second sublayer, and a third sublayer, wherein the second sublayer is between the first sublayer and the third sublayer, and the third sublayer is between the second sublayer and the electronic component.

10. The electronic device as claimed in claim 9, wherein the shielding layer has an opening exposing the top surface of the electronic component, the opening is defined by a first opening in the first sublayer, a second opening in the second sublayer, and a third opening in the third sublayer, and widths of the second opening and the third opening are greater than a width of the third opening.

11. The electronic device as claimed in claim 10, wherein a first gap is between the first sublayer and the electronic component, and the first gap is between 0.1 μm and 1 μm.

12. The electronic device as claimed in claim 1, wherein the recess has a bottom and a side connecting the bottom, a bottom end of the side of the recess and an adjacent side surface of the electronic component are separated by a first distance, and the first distance is greater than or equal to 10 μm and smaller than or equal to 100 μm.

13. The electronic device as claimed in claim 1, wherein the recess has a bottom and a side connecting the bottom, a top end of the side of the recess and an adjacent side of the shielding layer are separated by a second distance, and the second distance is greater than or equal to 10 μm and smaller than or equal to 100 μm.

14. The electronic device as claimed in claim 1, further comprising a protective layer surrounding and covering the shielding layer and the electronic component.

15. A method of manufacturing an electronic device, comprising:
providing a circuit structure, wherein the circuit structure has a first surface and a second surface opposite the first surface, the first surface has a first portion, a second portion, and a third portion, and the third portion connects the first portion and the second portion, wherein in a normal direction of the electronic device, the first portion and the second portion are farther away from the second surface than the third portion, thereby forming a recess;
disposing an electronic component in the recess of the circuit structure, wherein the electronic component is electrically connected to the circuit structure;
forming a shielding material layer on the electronic component and the circuit structure;
patterning the shielding material layer to form a shielding layer, wherein the shielding layer surrounds the electronic component; and
disposing an antenna unit on the first surface of the circuit structure, wherein the antenna unit is electrically connected to the electronic component through the circuit structure.

16. The method of manufacturing the electronic device as claimed in claim 15, wherein the recess has a bottom and a side connecting the bottom, a bottom end of the side of the recess and an adjacent side surface of the electronic component are separated by a first distance, and the first distance is greater than or equal to 10 μm.

17. The method of manufacturing the electronic device as claimed in claim 15, wherein the recess has a bottom and a side connecting the bottom, a top end of the side of the recess and an adjacent side of the shielding layer are separated by a second distance, and the second distance is greater than or equal to 10 μm.

18. The method of manufacturing the electronic device as claimed in claim 15, further comprising forming a protective layer surrounding and covering the shielding layer and the electronic component.

19. The method of manufacturing the electronic device as claimed in claim 15, further comprising disposing a first bonding element on the second surface of the circuit structure, wherein the first bonding element electrically connects to the electronic component.

20. The method of manufacturing the electronic device as claimed in claim 15, wherein the step of forming the shielding layer comprises a shielding sublayer formation process for forming a first sublayer on a patterned shielding material layer after patterning the shielding material layer.
